(19) United States
(12) Patent Application Publication
(10) Pub. No.: US 2008/0007663 A1
(43) Pub. Date: Jan. 10, 2008

(54) PLASMA DISPLAY PANEL

(75) Inventors: Fumiaki YOSHINO, Miyazaki (JP); Kanji KAWANO, Miyazaki (JP); Ikuo OZAKI, Miyazaki (JP); Akihiro FUJIMOTO, Miyazaki (JP); Toshihiro HORIUCHI, Miyazaki (JP)

Correspondence Address: STAAS & HALSEY LLP, SUITE 700, 1201 NEW YORK AVENUE, N.W., WASHINGTON, DC, 20005, US

(73) Assignee: Fujitsu Hitachi Plasma Display Limited, Miyazaki (JP)

(21) Appl. No.: 11/768,277

(22) Filed: Jun. 26, 2007

(30) Foreign Application Priority Data
Jul. 5, 2006 (JP) 2006-185563

(51) Int. Cl. G02F 1/137; H01J 9/00

(52) U.S. Cl. 349/32

(57) ABSTRACT

A high quality and highly reliable plasma display panel having a simple structure where it is possible to stably secure a uniform removal of impurities through the discharge of air from the inside of the panel is provided.

An airtight space between a front surface substrate 11 and a rear surface substrate 21 is a space surrounded by a sealing portion 45 in rectangular frame form. This airtight space is divided into two small airtight spaces, space A and space B, which are isolated from each other by one dividing wall 35 formed in the airtight space. The dividing wall 35 is formed so as to pass through the point of L/2 of each long side in a partition formed region 32 when the length of the long sides of the partition formed region 32 is denoted as L. Furthermore, the rear surface substrate 21 is provided with two air holes 38 and 39 so that the space A and the space B in the panel 10 are connected to the outside of the panel 10. End portions of air pipes 41 and 42 are connected to air holes 38 and 39, respectively.

### BACKGROUND OF THE INVENTION

The present invention relates to a plasma display panel (PDP), and in particular, to a surface discharge type PDP in an alternating current (AC) drive system which has partitions for dividing a light emitting region through discharge to every row and column.

PDP's in an AC drive system which are currently commercialized are generally a surface discharge type. In this specification, “surface discharge type” refers to a type where first and second displays electrodes which become a cathode and an anode, respectively, in a display discharge, which is the main discharge, are placed on the substrates on the front surface side and the rear surface side so as to be parallel to each other.

In surface discharge type PDP's, fluorescent layers for color display can be placed at a distance away from the pairs of display electrodes in the direction of the thickness of the panel, and thereby, deterioration of the fluorescent layer due to ion impact at the time of discharge can be reduced. Accordingly, surface discharge type PDP's are appropriate in terms of increasing longevity in comparison with facing discharge types where first and second display electrodes are placed so as to be distributed to the front surface substrate and the rear surface substrate.

The electrode matrix structure of the surface discharge types is typically a “three-electrode structure”. In addition, there is one example of this three-electrode structure where a great number of display electrodes, which makes surface discharge possible, are provided on the inner surface of one substrate (for example, front surface substrate) in the lateral direction (direction of the rows), and a great number of address electrodes for selecting light-emitting cells are provided on the inner surface of the other substrate (for example, rear surface substrate) in the direction crossing the display electrodes (direction of the columns) so that each intersection of a display electrode and an address electrode provides one cell (light emitting region unit).

This type of PDP according to the related art (for example, PDP shown in Patent Document 1: Japanese Unexamined Patent Publication 2000-82410) is manufactured by making the front surface substrate and the rear surface substrate which have been manufactured as described above face each other, joining and sealing the peripheries of the two substrates through a sealing portion in frame form so that an airtight space is formed between the two substrates, and after that, sealing a discharge gas in this airtight space.

This is described in further detail in the following. First, a frit glass, of which the main component is a glass powder having a low melting point, is applied to the periphery of the rear surface substrate in frame form. Then, temporary sintering is carried out on this frit glass so that a portion to be sealed is formed. After that, two substrates which are temporarily fixed with clips or the like to each other are put into a heating chamber so that the portion to be sealed is permanently sintered, and thereby, a sealing portion is formed, and at the same time, the two substrates are joined and sealed through the sealing portion so that an airtight space is created.

One air hole which is connected to the airtight space is provided to the rear surface substrate. An air pipe is connected to this air hole. Then, the air is discharged from the airtight space via the air pipe using an external vacuum pump so that the airtight space is made to be a vacuum. After that, a discharge gas is put into the airtight space via the air pipe from an external source for supplying a discharge gas so that the discharge gas is sealed in the airtight space.

### SUMMARY OF THE INVENTION

In general, the electrical properties of the panel of a PDP are greatly affected by the efficiency of gas discharge in the process of gas discharge after the above described sealing of the panel.

In accordance with the conventional method for discharging air from a PDP, however, as described above, air is discharged via one air pipe that is connected to one air hole which is provided in the rear surface substrate and connected to the airtight space so that the airtight space is made to be a vacuum.

As described above, air is discharged from the airtight space through only one air pipe so that the airtight space is made to be a vacuum, and therefore, the ability of removing impurities is lowered for a large scale panel having a large airtight space. In addition, it is difficult to discharge air uniformly from the entirety of the inside of the panel, and a problem arises where it is difficult for the pressure to be uniform inside the panel. Furthermore, the removal of impurities through the discharge of air from the inside of the panel becomes insufficient or becomes difficult, and thereby, there is a risk that a panel, of which the display properties are inconsistent, may be gained.

That is to say, in the case where the removal of impurities from the inside of a panel through the discharge of air becomes insufficient, there is a great risk that a reduction in brightness and a fluctuation in the voltage due to the deterioration of the fluorescent substance or inconsistency in the display properties within the panel surface due to such a fluctuation in the voltage may be caused.

In particular, in the center portion of the panel, the conductance of the discharge of air becomes smaller than in the peripheral portion, and the removal of impurities through the discharge of air becomes difficult. Therefore, it is considered that in the future situation where panels are large scale and the level of precision increases, the removal of impurities through the discharge of air is more difficult.

The present invention is provided while taking such a situation into consideration, and an object thereof is to provide a high quality and highly reliable plasma display panel having a simple structure where it is possible to stably secure a uniform removal of impurities through the discharge of air from the inside of the panel.

The present invention provides a plasma display panel comprising a pair of substrates which are placed so as to face each other, a plurality of partitions for dividing into a plurality of regions for emitting light through discharge formed between said pair of substrates, an airtight space created between the two substrates being joined and sealed by means of a sealing portion in frame form provided in the periphery of the substrates and a discharge gas sealed in this airtight space, the plasma display panel being characterized in that the airtight space is divided into n (n is an integer of no less than 2) small airtight spaces which are isolated from each other by dividing walls formed in the airtight space, and one substrate is provided with at least n air pipes so that at least one air pipe is connected to each of the small airtight spaces from the outside of this panel.

According to the present invention, the airtight space is divided into n small airtight spaces which are isolated from each other by dividing walls, and one substrate is provided with at least n air pipes so that at least one air pipe is connected to each of the small airtight spaces from the outside of the panel, and therefore, these air pipes make it possible to stably secure a uniform removal of impurities through the discharge of air from the inside of the panel, and thus, a high quality and highly reliable plasma display panel can be provided.

As for the pair of substrates (for example, a front surface substrate and a rear surface substrate) according to the present invention, substrates made of glass, quartz or ceramics, and substrates where a desired structure such as an electrode, an insulating film, a dielectric layer or a protective film is formed on any of the above described substrates are included.

A plurality of display electrodes may be provided on one substrate (for example, a front surface substrate) in such a manner as to extend in a certain direction. In addition, a plurality of address electrodes may be provided on the other substrate (for example, a rear surface substrate) in such a manner as to extend in a direction which crosses the display electrodes on the substrate.

The display electrodes and the address electrodes can be formed using a variety of materials and methods which are well-known in the art. As for the materials used for these electrodes, transparent conductive materials such as ITO and SnO₂ and metal conductive materials such as Ag, Au, Al, Cu and Cr can be cited as examples. As for the method for forming electrodes, a variety of methods which are well-known in the art can be applied. The electrodes may be formed using, for example, a technology for forming a thick film such as a screen printing method or a technology for forming a thin film made of a physical deposition method such as a vapor deposition method or a sputtering method or a chemical deposition method such as a thermal CVD method or an optical CVD method.

### BRIEF DESCRIPTION OF THE DRAWINGS

FIGS. 1(a) and 1(b) are diagrams showing the configuration of a PDP, wherein FIG. 1(a) is a diagram showing the entirety and FIG. 1(b) is an exploded perspective diagram showing a portion thereof;

FIG. 2 is a plan diagram showing a PDP according to the first embodiment of the present invention;

FIG. 3 is a perspective diagram showing an enlarged portion of the structure in the first embodiment as viewed in the direction a;

FIG. 4 is a graph showing a comparative experiment proving the properties of the discharge of air from the panel in the first embodiment;

FIG. 5 is a plan diagram showing a PDP according to the second embodiment of the present invention;

FIG. 6 is a plan diagram showing a PDP according to the third embodiment of the present invention;

FIG. 7 is a plan diagram showing a PDP according to the fourth embodiment of the present invention; and

FIG. 8 is a plan diagram showing a PDP according to the fifth embodiment of the present invention.

### DETAILED DESCRIPTION OF THE PREFERRED EMBODIMENTS

In the following, the embodiments of the invention are described in detail on the basis of the modes shown in the drawings. Here, the present invention is not limited to these, and a variety of modifications are possible.

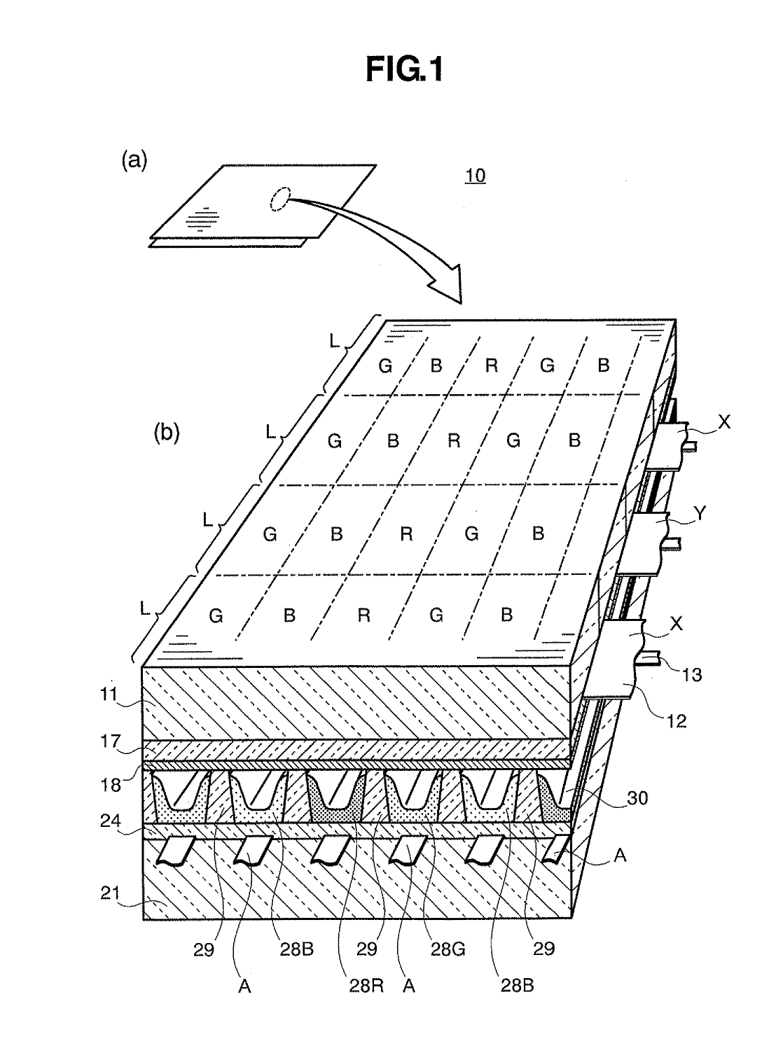

FIGS. 1(a) and 1(b) are diagrams showing the configuration of a PDP. FIG. 1(a) is a diagram showing the entirety, and FIG. 1(b) is an exploded perspective diagram showing a portion.

A PDP 10 is a three-electrode surface discharge type PDP in an AC drive type for color display which is formed of a front surface substrate 11 and a rear surface substrate 21. As for the substrate 11 and the substrate 21, glass substrates, quartz substrates, ceramic substrates and the like can be used.

Display electrodes X and display electrodes Y, which extend in the horizontal direction, are placed at equal intervals on the inner surface of the front surface substrate 11. All the portions between adjacent display electrodes X and display electrodes Y become display lines L. Here, though this PDP 10 is a PDP having a so-called ALIS structure where the display electrodes X and the display electrodes Y are placed at equal intervals and all the portions between the adjacent display electrodes X and the display electrodes Y become display lines L, the embodiment can be applied to PDP's having a structure where display electrodes X and display electrodes Y, which make pairs, may be placed at intervals (non-discharge gaps) where no discharge occurs.

The display electrodes X and Y, respectively, are formed of a transparent electrode 12 having a wide width made of ITO, SnO₂ or the like and a BUS electrode 13 having a narrow width made of a metal or metals such as Ag, Au, Al, Cu, Cr or layered bodies of these (for example, layered structure of Cr/Cu/Cr). A desired number of display electrodes X and Y having a desired thickness and width can be formed at desired intervals by using a technology for forming a thick film such as screen printing for Ag or Au, and a technology for forming a thin film such as a deposition method or a sputtering method and an etching technology for other metals.

A dielectric layer 17 is formed on top of the display electrodes X and Y so as to cover the display electrodes X and Y. The dielectric layer 17 is formed by applying a frit paste, of which the main component is a glass powder having a low melting point, to the top of the front surface substrate 11 in accordance with a screen printing method, and then sintering the frit paste. The dielectric layer 17 may be formed by growing a SiO₂ film in accordance with a plasma CVD method.

A protective film 18 for protecting the dielectric layer 17 from damage as a result of ion impacts caused by the discharge at the time of display is formed on top of the dielectric layer 17. This protective film 18 is formed of MgO. The protective film 18 can be formed in a process for forming a thin film, which is well-known in the art, such as an electron beam deposition method or a sputtering method.

A plurality of address electrodes A are formed on the inner surface of the rear surface substrate 21 in a direction which crosses the display electrodes X and Y in a plan view, and a dielectric layer 24 is formed so as to cover these address electrodes A. The address electrodes A are provided to make address discharge occur in order to select light-emitting cells from the intersections with the display electrodes Y, and are formed so as to have a three-layer structure of Cr/Cu/Cr.

The address electrodes A can be formed of, for example, Ag, Au, Al, Cu or Cr instead of that in the above. A desired number of address electrodes A having a desired thickness and width can be formed at desired intervals by using a technology for forming a thick film such as screen printing for Ag or Au, and a technology for forming a thin film such as a deposition method or a sputtering method and an etching technology for other metals in the same manner as the display electrodes X and Y. The dielectric layer 24 can be formed using the same materials and the same methods as the dielectric layer 17.

A plurality of partitions 29 are formed on top of the dielectric layers 24 between the adjacent address electrodes A. The partitions 29 are in stripe form. Here, the partitions may be in grid form.

The partitions 29 can be formed in accordance with a sandblasting method, a photo-etching method or the like. In accordance with a sandblasting method, for example, a glass paste made of glass having a low melting point, a binder resin, a solvent and the like is applied to the top of the dielectric layer 24 and dried, and after that, cutting particles are blown against this glass paste layer in a state where a cutting mask having openings in a partition pattern is provided on top of this glass paste layer so that the glass paste layer exposed from the openings of the mask is cut, and furthermore, the glass paste layer is sintered, and thus, the partitions are formed. In addition, in accordance with a photo-etching method, cutting with cutting particles is not carried out, but instead, a photo-sensitive resin is used as the binder resin, and the glass paste is exposed to light using a mask and developed, and after that, the glass paste is sintered, and thus, the partitions are formed.

Fluorescent layers 28R, 28G and 28B for red (R), green (G) and blue (B) are formed on the sides and the bottoms of the discharge spaces surrounded by the partitions 29. The fluorescent layers 28R, 28G and 28B are formed by applying a fluorescent paste containing a fluorescent powder, a binder resin and a solvent to the partitions 29 which surround the discharge spaces in accordance with screen printing or a method using a dispenser, repeating this process for each color, and after that, sintering the fluorescent paste.

The fluorescent layers 28R, 28G and 28B can be formed in accordance with a photolithographic technology using a material for a fluorescent layer in sheet form (so-called green sheet) which contains a fluorescent powder, a photo-sensitive material and a binder resin. In this case, a sheet of a desired color is pasted to the entire surface of the display region on the substrate, and then, exposed to light and developed, and this process is repeated for each color, and thereby, fluorescent layers of each color can be formed between the corresponding partitions.

This PDP 10 is fabricated by placing the front surface substrate 11 and the rear surface substrate 21 so that they face each other and the display electrodes X and Y cross the address electrodes A, sealing the surroundings and filling discharge spaces 30 surrounded by the partitions 29 with a discharge gas where Xe and Ne are mixed. In this PDP, a discharge space 30 at the intersection of a display electrode X or Y and an address electrode A becomes one cell (light emitting region unit) which is the minimum unit for display. One pixel is formed of three cells of R, G and B.

### First Embodiment

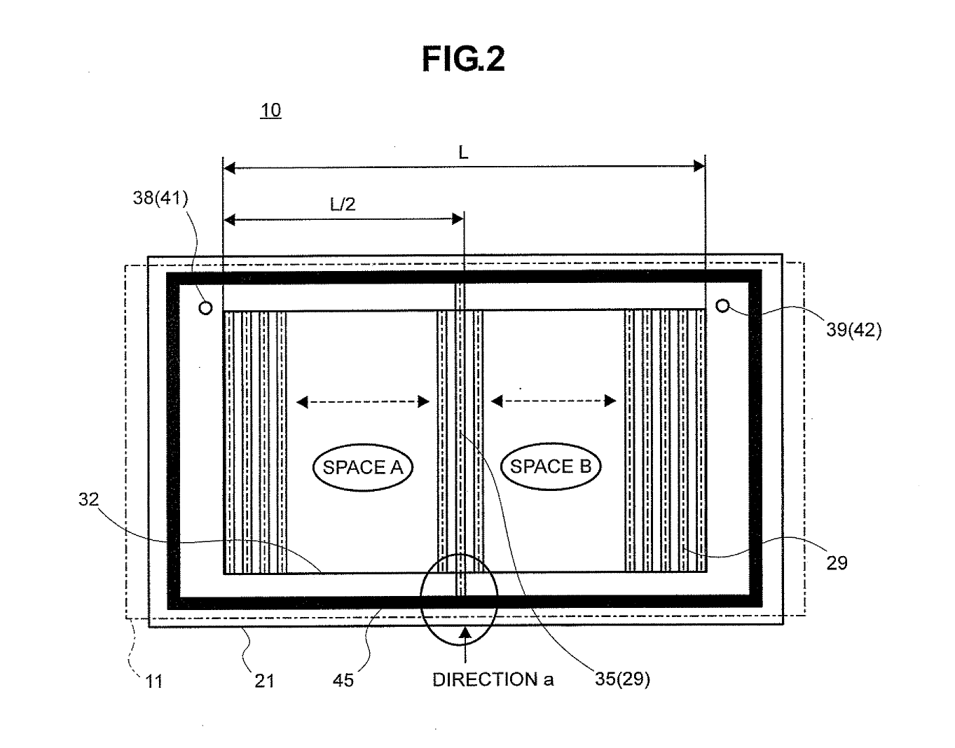

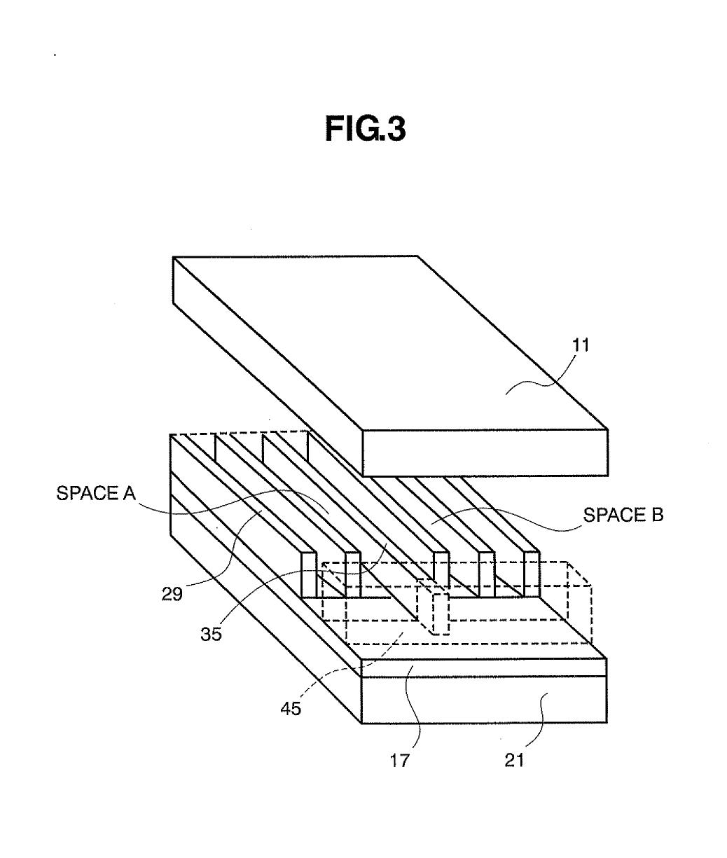

FIG. 2 is a plan diagram showing a PDP 10 according to the first embodiment. FIG. 3 is a perspective diagram showing an enlarged portion of the structure of the first embodiment as viewed in the direction a.

First, the structure of the PDP 10 shown in FIG. 2 is described. Display electrodes X and Y, a dielectric layer 17 and a protective film 18 made of MgO are formed on a front surface substrate 11. In order to describe this embodiment in detail, FIG. 2 shows the rectangular front surface substrate 11 with a one-dot chain line, and the display electrodes X and Y are not shown.

A plurality of address electrodes A (not shown) and a plurality of partitions 29 are formed on a rectangular rear surface substrate 21. These partitions 29 are provided in accordance with a sandblasting method using a glass paste. In addition, fluorescent layers 28R, 28G and 28B (not shown) are formed on the surfaces of the partitions 29.

A sealing portion 45 in rectangular frame form is provided around the periphery of the rear surface substrate 21 so that the space that is formed between the front surface substrate 11 and the rear surface substrate 21 when they are overlapped is sealed airtight. The sealing portion 45 is formed in the following manner.

That is to say, first, a frit glass, of which the main component is a glass powder having a low melting point, is applied to the periphery of the rear surface substrate 21 in rectangular frame form. Then, this frit glass is temporarily sintered so that a portion to be sealed is formed. Next, the rear surface substrate 21 and the front surface substrate 11 are overlapped, and the surroundings are temporarily fixed with clips or the like. After that, the two substrates 21 and 11, which are temporarily fixed to each other, are put into a heating chamber so that the portion to be sealed is permanently sintered, and thereby, the sealing portion 45 is formed. The two substrates 21 and 11 are joined and sealed through the sealing portion 45, and thus, an airtight space is created between the two substrates 21 and 11.

The airtight space between the two substrates 21 and 11 is a space surrounded by the sealing portion 45 in rectangular frame form. This airtight space is divided into two small airtight spaces, space A and space B, which are isolated from each other by one dividing wall 35 formed in the airtight space.

As shown in FIG. 2, a plurality of partitions 29 are formed in a predetermined pitch in accordance with air discharge properties in a rectangular partition formed region 32, excluding the periphery of the two substrates 21 and 11 from the airtight space. In addition, as shown in FIGS. 2 and 3, the dividing wall 35 is formed of the partition 29 at the center from among a plurality of partitions 29, and the two end portions thereof, which are respectively extended to the sealing portion 45 and traverse the partition formed region 32 in the direction of the length.

The dividing wall 35 is formed so as to pass the point of L/2 of each long side of the partition formed region 32 when the length of the long sides of the partition formed region 32 is denoted as L. In this manner, one dividing wall 35 divides the volume of the airtight space within the panel into halves, and thereby, two small airtight spaces, space A and space B, are created.

Furthermore, two air holes 38 and 39 are created in the rear surface substrate 21 so that the space A and the space B in the panel 10 are connected to the outside of the panel 10. These air holes 38 and 39 are respectively provided in a corner portion outside of the partition formed region 32. In addition, end portions of air pipes 41 and 42 are respectively connected to the air holes 38 and 39. A frit glass is applied to the connection portions between the air hole 38 and the air pipe 41 as well as between the air hole 39 and the air pipe 42.

The air pipes 41 and 42 are used in order to discharge air from the space A and the space B so that these spaces are made to be a vacuum by means of an external vacuum pump, and after the discharge of air, to put a discharge gas into the space A and the space B from an external source for supplying a discharge gas so that the discharge gas is sealed in the spaces A and B.

As described above, in the conventional method for discharging air from a PDP, air is discharged via one air pipe that is connected to one air hole which is provided in the rear surface substrate and connected to the airtight space so that the airtight space is made to be a vacuum. Therefore, in the case of a large scale panel having a large air tight space, a problem arises where the ability of removing impurities deteriorates.

In contrast, in the PDP 10 according to the first embodiment, the airtight space is divided into two small airtight spaces, space A and space B, which are isolated from each other by one dividing wall 35 formed in the airtight space, and in addition, the air pipe 41 is connected to the space A and the air pipe 42 is connected to the space B. Accordingly, air can be discharged from the space A and the space B through the two air pipes 41 and 42, respectively, so that the spaces A and B can be effectively made to be a vacuum.

That is to say, this PDP 10 makes it possible to stably secure a uniform removal of impurities through the discharge of air from the inside of the panel, and thus, a high quality and highly reliable plasma display panel can be provided.

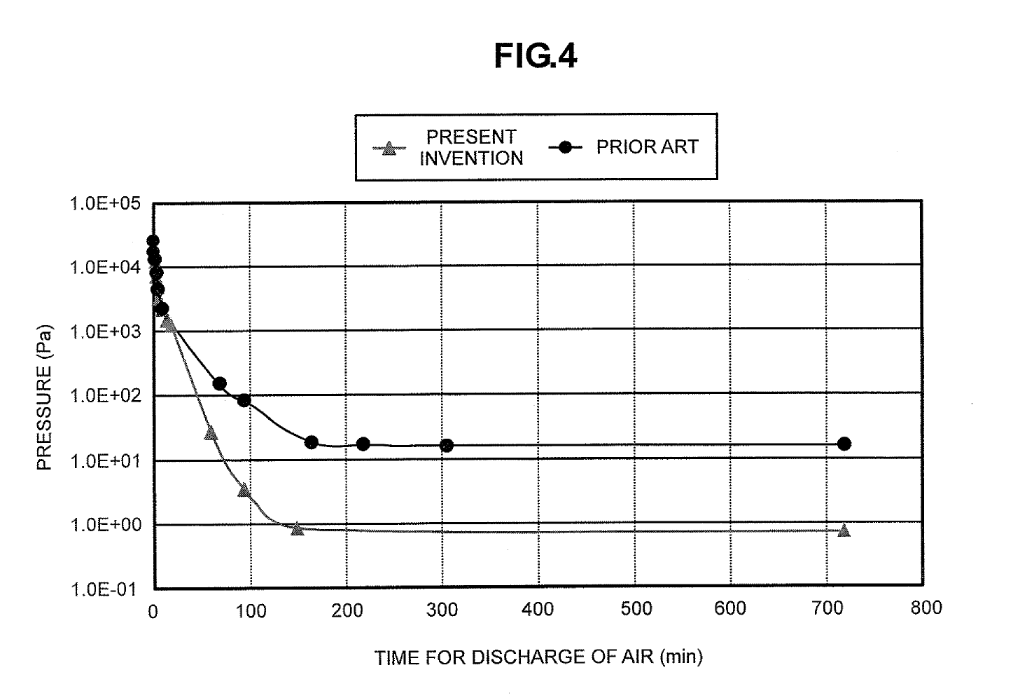

FIG. 4 is a graph showing an experiment comparing the air discharge properties within the panel in order to prove the above described effects of the first embodiment. The longitudinal axis shows the pressure (Pa) within the panel when air is discharged from the inside of the panel, and the lateral axis shows the time for the discharge of air (min). In FIG. 4, indicates the results of an experiment in the case where a conventional PDP as described above was used, and ▴ indicates the results of an experiment in the case where the PDP 10 of the first embodiment was used. Here, 1.0E−01, 1.0E+00, 1.0E+01, . . . and 1.0E+05 along the longitudinal axis of FIG. 4 mean 10⁻¹, 10⁰, 10¹, . . . and 10⁵, respectively.

As shown in FIG. 4, though a change in pressure until the time for the discharge of air becomes approximately 20 minutes is almost the same between the two, a difference is perceived from 20 minutes to approximately 90 minutes. In addition, it can be seen that when the time for the discharge of air exceeds 90 minutes, the pressure within the panel of the PDP 10 of the first embodiment is no less than 1 digit (one tenth) smaller than that of the conventional PDP.

As described above, the amount of the impurity gas which remains within the panel becomes extremely small in comparison with the conventional panel when the PDP 10 of the first embodiment is used, and thus, it can be seen that the quality and the reliability of the panel are greatly improved.

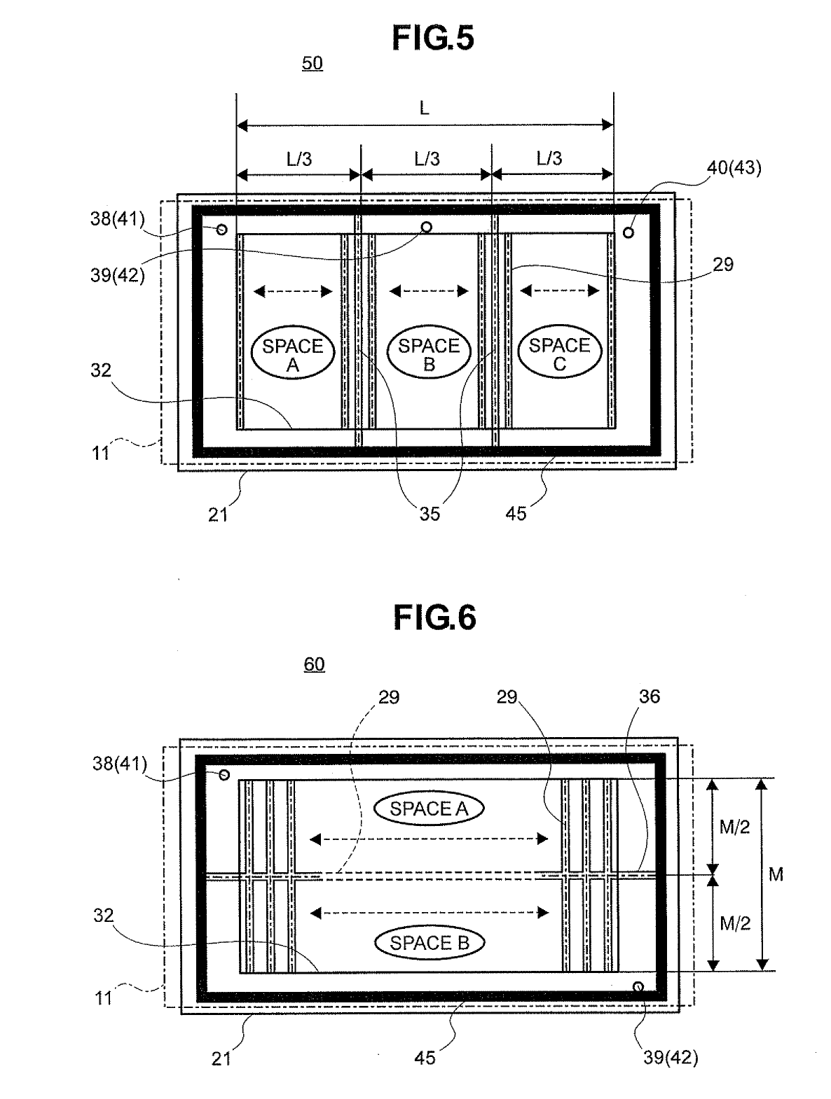

In the first embodiment, as shown in FIG. 2, a method for dividing the airtight space into halves by means of a dividing wall 35 which passes through the point of L/2 of each long side of the partition formed region 32 is described as an embodiment. Next, some other methods for dividing the airtight space are described in reference to FIGS. 5 to 8.

### Second Embodiment

FIG. 5 is a plan diagram showing a PDP 50 according to the second embodiment. That is to say, in this PDP 50, two dividing walls 35 are formed on a rear surface substrate 21, and these dividing walls 35 and 35 are formed so as to pass through the points of L/3 of each long side of the partition formed region 32. In this manner, the two dividing walls 35 and 35 divide the volume of the airtight space within the panel into thirds, and thereby, three small airtight spaces, space A, space B and space C, are created.

In addition, three air holes 38, 39 and 40 are created in the rear surface substrate 21 so that the space A, the space B and the space C in the panel 50 are connected to the outside of the panel 50. These air holes 38, 39 and 40 are respectively provided in a corner portion or in a middle portion outside the partition formed region 32. In addition, end portions of air pipes 41, 42 and 43 are connected to the air holes 38, 39 and 40, respectively.

In the PDP 50 according to the second embodiment, the airtight space is divided into three small airtight spaces, space A, space B and space C, which are isolated from each other by two dividing walls 35 and 35 formed in the airtight space, and in addition, the air pipe 41 is connected to the space A, the air pipe 42 is connected to the space B and the air pipe 43 is connected to the space C. Accordingly, air can be discharged from the space A, the space B and the space C through the three air pipes 41, 42 and 43, respectively, so that the spaces A, B and C can be effectively made to be a vacuum.

### Third Embodiment

FIG. 6 is a plan diagram showing a PDP 60 according to the third embodiment. That is to say, in this PDP 60, one dividing wall 36 is formed on a rear surface substrate 21, and the dividing wall 36 is formed of the partition 29, which perpendicularly crosses a plurality of partitions 29 in the respective center portions, and two end portions thereof, which traverse the partition formed region 32 and are extended to the sealing portion 45 in the direction of the length.

In addition, the dividing wall 36 is formed so as to pass through the point of M/2 of each short side in the partition formed region 32 when the length of the short sides of the partition formed region 32 is denoted as M. In this manner, the volume of the airtight space within the panel is divided into halves by one dividing wall 36, and thereby, two small airtight spaces, space A and space B, are created.

Furthermore, two air holes 38 and 39 are created in the rear surface substrate 21 so that the space A and the space B of the panel 60 are connected to the outside of the panel 60. These air holes 38 and 39 are respectively provided in a corner portion outside the partition formed region 32. In addition, end portions of air pipes 41 and 42 are connected to the air holes 38 and 39, respectively.

In the PDP 60 according to the third embodiment, the airtight space is divided into two small airtight spaces, the space A and the space B, which are isolated from each other by one dividing wall 36 formed in the airtight space, and in addition, the air pipe 41 is connected to the space A and the air pipe 42 is connected to the space B. Accordingly, air can be discharged from the space A and the space B through the two air pipes 41 and 42, respectively, so that the spaces A and B can be effectively made to be a vacuum.

### Fourth Embodiment

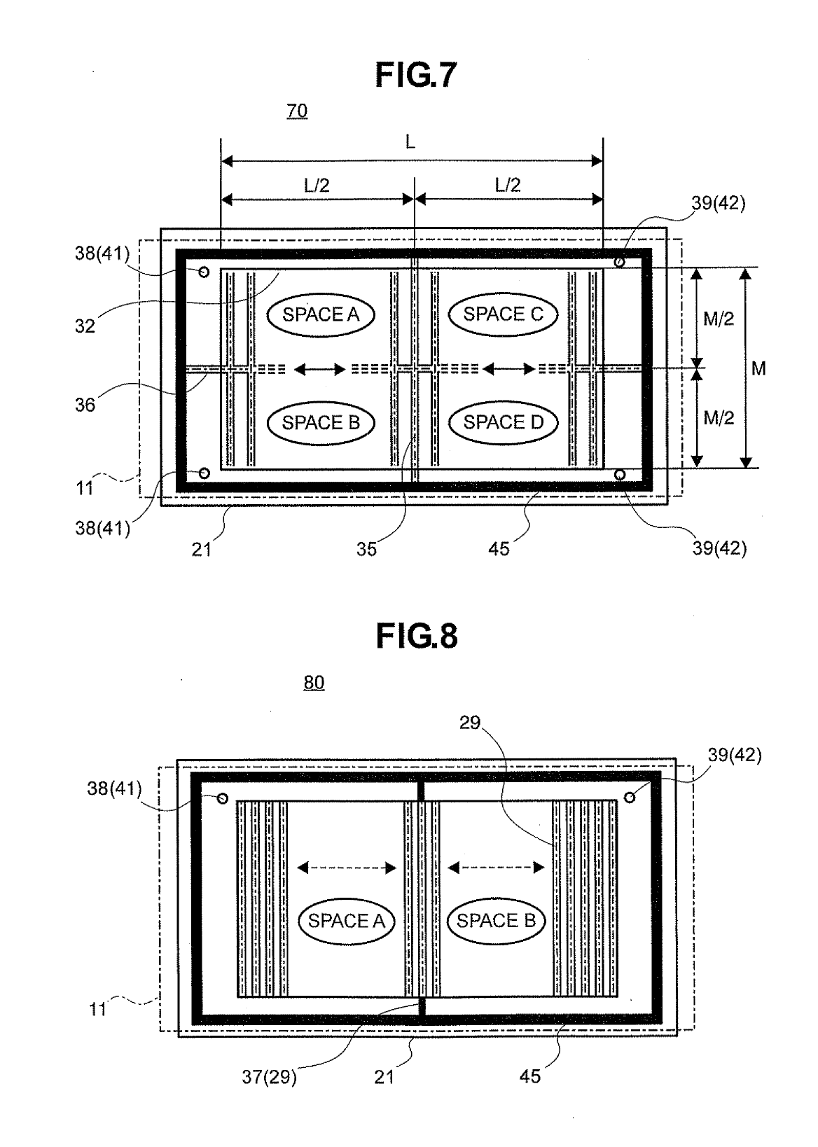

FIG. 7 is a plan diagram showing a PDP 70 according to the fourth embodiment. That is to say, in this PDP 70, one dividing wall 35 and another dividing wall 36, which perpendicularly crosses the dividing wall 35, are formed on a rear surface substrate 21, and the dividing wall 35 is formed so as to pass through the point of L/2 of each long side of the partition formed region 32 and the dividing wall 36 is formed so as to pass through the point of M/2 of each short side of the partition formed region 32.

Thus, the two dividing walls 35 and 36 divide the volume of the airtight space within the panel into quarters, and thereby, four small airtight spaces, space A, space B, space C and space D, are created.

Four air holes 38, 39, 38 and 39 are created in the rear surface substrate 21 so that the space A, the space B, the space C and the space D in the panel 70 are connected to the outside of the panel 70. These air holes 38, 39, 38 and 39 are respectively provided in a corner portion outside the partition formed region 32. In addition, end portions of air pipes 41, 42, 41 and 42 are connected to the air holes 38, 39, 38 and 39, respectively.

In the PDP 70 according to the fourth embodiment, the airtight space is divided into four small airtight spaces, space A, space B, space C and space D which are isolated from each other by two dividing walls 35 and 36 formed in the airtight space, and in addition, the air pipe 41 is connected to the space A, the air pipe 41 is connected to the space B, the air pipe 42 is connected to the space C and the air pipe 42 is connected to the space D. Accordingly, air can be discharged from the space A, the space B, the space C and the space D through the four air pipes 41, 42, 41 and 42, respectively, so that the spaces A, B, C and D can be effectively made to be a vacuum.

### Fifth Embodiment

FIG. 8 is a plan diagram showing a PDP 80 according to the fifth embodiment. That is to say, a dividing wall 37 in this PDP 80 is formed of the partition 29 at the center from among the number of partitions 29 and portions of the sealing portion 45 which extend to the two end portions of the partition 29, respectively.

In this manner, the one dividing wall 37 divides the volume of the airtight space within the panel into halves, and thereby, two small airtight spaces, space A and space B, are created.

Furthermore, two air holes 38 and 39 are created in the rear surface substrate 21 so that the space A and the space B in the panel 80 are connected to the outside of the panel 80. These air holes 38 and 39 are respectively provided in a corner portion outside the partition formed region 32. In addition, end portions of air pipes 41 and 42 are connected to the air holes 38 and 39, respectively.

In the PDP 80 according to the fifth embodiment, the airtight space is divided into two small airtight spaces, space A and space B, which are isolated from each other by one dividing wall 37 formed in the airtight space, and in addition, the air pipe 41 is connected to the space A and the air pipe 42 is connected to the space B. Accordingly, air can be discharged from the space A and the space B through the two air pipes 41 and 42, respectively, so that the spaces A and B can be effectively made to be a vacuum.

What is claimed:

1. A plasma display panel comprising a pair of substrates which are placed so as to face each other, a plurality of partitions for dividing into a plurality of regions for emitting light through discharge formed between said pair of substrates, an airtight space created between the two substrates being joined and sealed by means of a sealing portion in frame form provided in the periphery of the substrates and a discharge gas sealed in this airtight space, the plasma display panel being characterized in that
the airtight space is divided into n (n is an integer of no less than 2) small airtight spaces which are isolated from each other by dividing walls formed in the airtight space, and one substrate is provided with at least n air pipes so that at least one air pipe is connected to each of the small airtight spaces from the outside of this panel.

2. A plasma display panel according to claim 1, wherein the dividing wall is made by extending a portion of the partition.

3. A plasma display panel according to claim 1, wherein the dividing wall is made by extending a portion of the sealing portion.

4. A plasma display panel according to claim 1, wherein the partitions are formed in a rectangular partition formed region, which is a region gained by excluding the periphery of the two substrates from the airtight space, and the dividing walls are formed so as to pass through the points of L/n of each long side in the partition formed region when the length of the long sides of the partition formed region is denoted as L.

5. A plasma display panel according to claim 1, wherein the partitions are formed in a rectangular partition formed region, which is a region gained by excluding the periphery of the two substrates from the airtight space, and the dividing walls are formed so as to pass through the points of M/n of each short side in the partition formed region when the length of the short sides of the partition formed region is denoted as M.

6. A plasma display panel according to claim 1, wherein the partitions are formed in a rectangular partition formed region, which is a region gained by excluding the periphery of the two substrates from the airtight space, and the dividing walls are formed so as to pass through the points of L/n of each long side and the points of M/n of each short side in the partition formed region when the length of the long sides of the partition formed region is denoted as L and the length of the short sides is denoted as M.

7. A plasma display panel, comprising:
a pair of substrates opposed to each other;
a space formed between the pair of substrates;
a sealing portion formed in the periphery area of the substrates, the sealing portion seals the space between the pair of substrates;
a space dividing wall which divides the space into a plurality of small spaces isolated from each other in the space; and
a discharge gas is filled and sealed in the plurality of small spaces.

8. A plasma display panel according to claim 7,
wherein the discharge gas is filled in the plurality of small spaces through a plurality of air pipes connected to the plurality of small spaces.

9. A plasma display panel according to claim 7,
wherein the discharge gas is filled in each of the small space through a plurality air pipes connected to each of the small spaces.

10. A plasma display panel according to claim 7,
wherein the space dividing wall is made by extending a portion of the partition.

11. A plasma display panel according to claim 7,
wherein the space dividing wall is made by extending a portion of the sealing portion.

12. A method for manufacturing a plasma display panel, comprising:
providing a front substrate and a back substrate;
sealing a space between the front substrate and the back substrate in the periphery area of the substrates; and
exhausting air from the space;
wherein the sealed space is divided into a plurality of small spaces isolated from each other by a space dividing wall, and the air in each of the small space is exhausted through air pipes connected to each of the small space.

13. A method for manufacturing a plasma display panel according to claim 12,
wherein a discharge gas is filled in each of the small space through the air pipes connected to each of the small space.

14. A method for manufacturing a plasma display panel according to claim 12,
wherein a discharge gas is filled in each of the small space through the air pipes connected to each of the small space after the air is exhausted from each of the small space.

15. A method for manufacturing a plasma display panel according to claim 12,
wherein the space dividing wall is made by extending a portion of the partition.

16. A method for manufacturing a plasma display panel according to claim 12,
wherein the space dividing wall is made by extending a portion of the sealing portion.
